(19) United States
(12) Patent Application Publication
(10) Pub. No.: US 2006/0190167 A1
(43) Pub. Date: Aug. 24, 2006

(54) Navigation apparatus and method, and navigation program

(76) Inventor: Yuu Inukai, Fukuoka (JP)

Correspondence Address: WENDEROTH, LIND & PONACK, L.L.P., 2033 K STREET N. W., SUITE 800, WASHINGTON, DC, 20006-1021, US

(21) Appl. No.: 10/549,154

(22) PCT Filed: Oct. 19, 2004
(86) PCT No.: PCT/JP04/15442

§ 371 Date: Sep. 15, 2005

(30) Foreign Application Priority Data
Oct. 20, 2003 (JP) 2003-359442

(51) Int. Cl. G01C 21/30

(52) U.S. Cl. 701/209

(57) ABSTRACT

A navigation apparatus and method, and a navigation program are provided which allow a user to recognize a route safely in advance, without turning his or her eyes to a display screen or the like.

The navigation apparatus includes a route search section (22) for performing a search for a route from a starting point to a destination; a sound processing control section (23) for performing a guide using sound based on the route derived from the search; and a route outline generation section (25) for generating an outline of the route to be presented, prior to the guidance. The sound processing control section (23) presents a route outline by use of sound prior to the guidance via a sound processing section (19) and a loudspeaker (6). The user is able to recognize the route safely in advance, even in a situation where he or she cannot turn his or her eyes, e.g., while driving.

### TECHNICAL FIELD

The present invention relates to a navigation apparatus and method, and a navigation program, and, more particularly, to a navigation apparatus and method, and a navigation program for performing route guidance employing sound.

### BACKGROUND ART

Conventionally, there is known a navigation apparatus which displays on a screen a result of computation of a route to a destination before actually conducting route guidance, thereby allowing a user to recognize the route in advance. There is also proposed a driving simulation method which moves a virtual vehicle along a guidance route and displays, on a display, guidance information representing the same movement as an actual vehicle would make along the route, in order for a user to recognize the route in advance which has been set (see, for example, Patent Document 1).

Patent Document 1: Japanese Laid-Open Patent Publication No. 9-218048

### DISCLOSURE OF THE INVENTION

### Problems to be Solved by the Invention

However, in the above-described conventional navigation apparatus and method, the route is displayed on the screen to allow the computed route to be recognized in advance. Therefore, in a situation where the user is to drive a vehicle while carefully looking forward, the user is obliged to turn his or her gaze upon the screen to recognize the route resulting from the computation, creating a possibility of disturbing concentration on driving.

Therefore, an object of the present invention is to provide a navigation apparatus and method, and a navigation program which allow the user to recognize the route safely in advance, without having to turn his or her gaze upon a display screen, etc.

### SOLUTION TO THE PROBLEMS

To achieve the object above, the present invention has the following features.

A first invention is a navigation apparatus for performing a route guidance by use of sound based on a route which is set. The navigation apparatus includes a map information acquisition section, a present position detection section, a route search section, a route outline generation section, and a sound processing control section. The map information acquisition section acquires pieces of map information. The present position detection section detects a present position. The route search section performs a search for a route from a starting point to a destination, while employing the pieces of map information acquired by the map information acquisition section, to set the route. The route outline generation section generates outline data of the route by appropriately selecting a piece of map information as to the route set by the route search section. The sound processing control section performs a guidance of the route by use of sound based on the present position in the route set by the route search section. Based on the outline data of the route generated by the route outline generation section, the sound processing control section presents information of an outline of the route by use of sound, before performing the guidance of the route based on the present position.

According to a second invention based on the above-described first invention, the route outline generation section generates the outline data of the route such that a sound reproduction time period in which the sound processing control section presents the information of the outline of the route by use of sound is limited to a predetermined length.

According to a third invention based on the above-described first invention, the route outline generation section assigns priority rankings to respective information types, and appropriately selects a piece of information based on the priority rankings to generate the outline data of the route.

According to a fourth invention based on the above-described third invention, the route outline generation section varies the priority rankings assigned to the respective information types, in accordance with a total distance of the route set by the route search section.

According to a fifth invention based on the above-described fourth invention, when the total distance of the route set by the route search section is relatively short, the route outline generation section performs assignment of the priority rankings such that high priority rankings are set for pieces of information as to an intersection where a turn is to be made in the route and a landmark near the intersection.

According to a sixth invention based on the above-described fourth invention, when the total distance of the route set by the route search section is relatively long, the route outline generation section performs the assignment of the priority rankings such that high priority rankings are set for pieces of information as to a distance of, an estimated driving time for, and a road name for the route.

According to a seventh invention based on the above-described third invention, the route outline generation section divides the route set by the route search section into a predetermined number of parts, and varies the priority rankings assigned to the respective information types belonging to each area obtained by division.

According to an eighth invention based on the above-described seventh invention, the route outline generation section performs the assignment of the priority rankings such that higher priority rankings are set for an information type belonging to an area including the starting point than for an identical information type belonging to another area.

A ninth invention is a navigation program to be executed by a computer in a navigation apparatus for performing a route guidance by use of sound based on a route which is set. The navigation program causes the computer to perform a map information acquisition step, a present position detection step, a route search step, a route outline generation step, and a sound processing control step. The map information acquisition step acquires pieces of map information. The present position detection step detects a present position. The route search step performs a search for a route from a starting point to a destination, while employing the pieces of map information acquired by the map information acquisition step, to set the route. The route outline generation step generates outline data of the route by appropriately selecting a piece of map information as to the route set by the route search step. The sound processing control step performs a guidance of the route by use of sound based on the present position in the route set by the route search step. Based on the outline data of the route generated by the route outline generation step, the sound processing control step presents information of an outline of the route by use of sound, before performing the guidance of the route based on the present position.

A tenth invention is a navigation method for performing a route guidance by use of sound based on a route which is set. The navigation method includes a map information acquisition step, a present position detection step, a route search step, a route outline generation step, and a sound processing control step. The map information acquisition step acquires pieces of map information. The present position detection step detects a present position. The route search step performs a search for a route from a starting point to a destination, while employing the pieces of map information acquired by the map information acquisition step, to set the route. The route outline generation step generates outline data of the route by appropriately selecting a piece of map information as to the route set by the route search step. The sound processing control step performs a guidance of the route by use of sound based on the present position in the route set by the route search step. Based on the outline data of the route generated by the route outline generation step, the sound processing control step presents information of an outline of the route by use of sound, before performing the guidance of the route based on the present position.

### EFFECT OF THE INVENTION

The above-described first invention makes it possible to provide to a user an outline of a route by use of sound before starting an actual route guidance following the setting of the route. Thus, the user is able to recognize the route safely in advance even in a situation where he or she cannot turn his or her eyes, e.g., while driving. At this time, a route outline which allows the user to easily understand the route is presented, so that the user can efficiently recognize the route which is presented.

The above-described second invention makes it possible to present a route outline within an appropriate length of reproduction time, saving the user from becoming irritated because of a long reproduction time for sound with which the outline of the route is presented to the user.

The above-described third invention makes it possible to present a simple guidance of a grasped feature of the set route by setting a high priority ranking for a piece of information suitable for a route outline guidance, enabling the user to easily understand the outline of the route.

The above-described fourth invention makes it possible to perform a route outline guidance using an appropriate piece of information in accordance with the total distance of the set route, according to which total distance, the type of information required by the user generally varies.

According to the above-described fifth invention, in the case of a route in which the destination is located relatively close to the starting point, necessary information is generally the name of an intersection where a turn is to be made in the route, a landmark for a point where a turn is to be made, etc., rather than the distance of or the estimated driving time for the set route; to satisfy such a requirement, it is possible to adopt an appropriate piece of information for the route outline guidance.

According to the above-described sixth invention, in the case of a route in which the destination is located relatively far from the starting point, necessary information is generally a piece of information which enables the grasp of the entire route rather than detailed intersection information or a piece of information as to the name of a road which is not a main road; to satisfy such a requirement, it is possible to adopt an appropriate piece of information for the route outline guidance.

According to the above-described seventh invention, in general, information required for an outline may vary in accordance with areas in a route; to satisfy such a requirement, it is possible to adopt an appropriate piece of information for the route outline guidance.

According to the above-described eighth invention, even in a route in which the destination is relatively far, for example, information as to a intersection close to the starting point and where a turn is to be made is important; to satisfy such a requirement, it is possible to adopt an appropriate piece of information for the route outline guidance.

Also, the navigation program and the navigation method according to the present invention achieve effects similar to those of the above-described navigation apparatus.

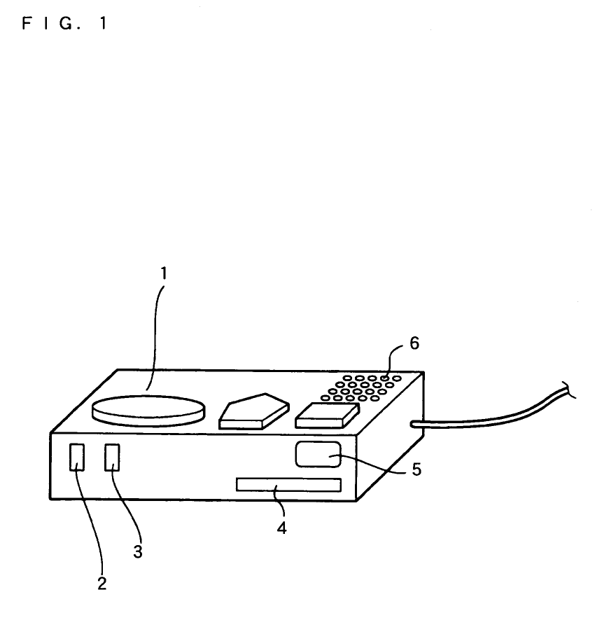

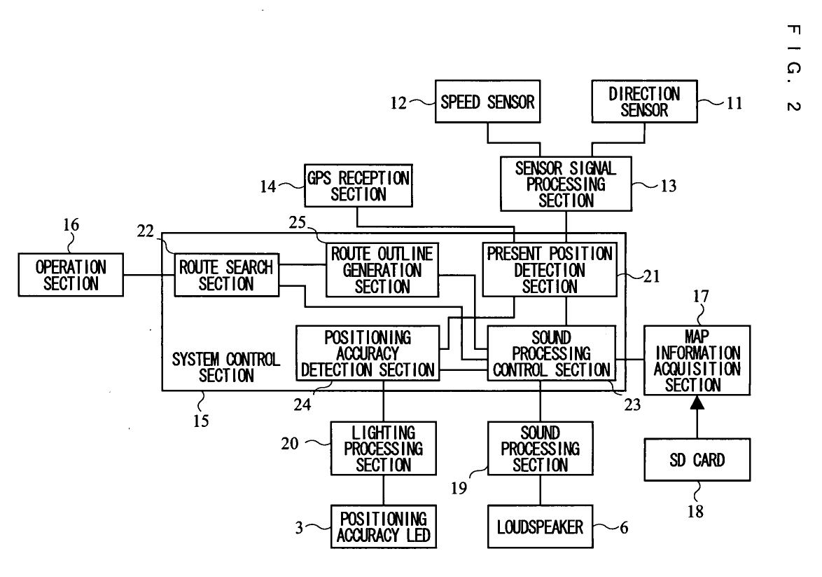

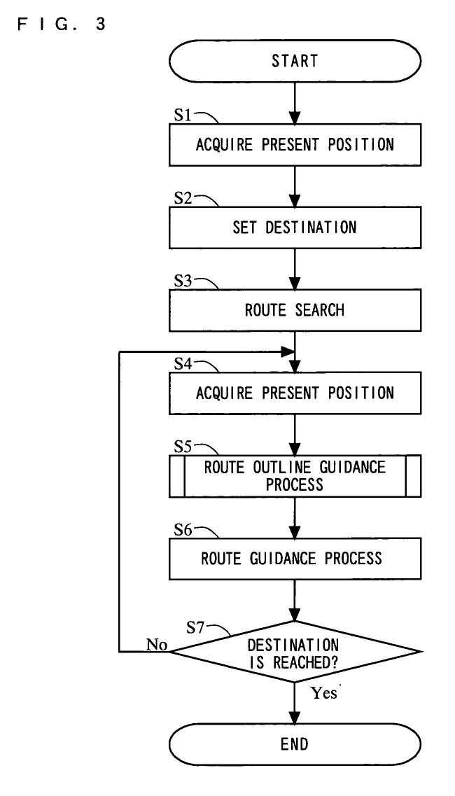

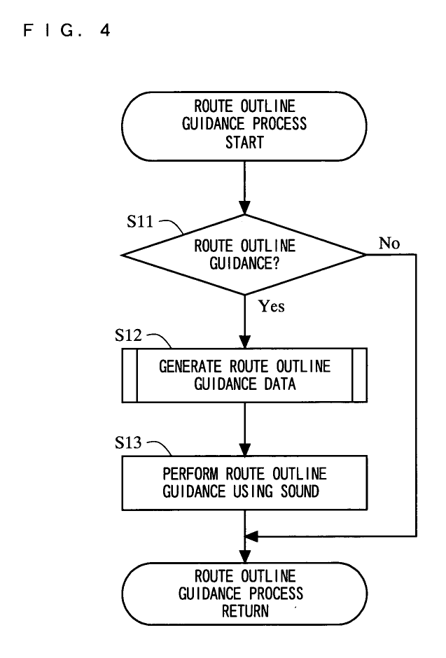

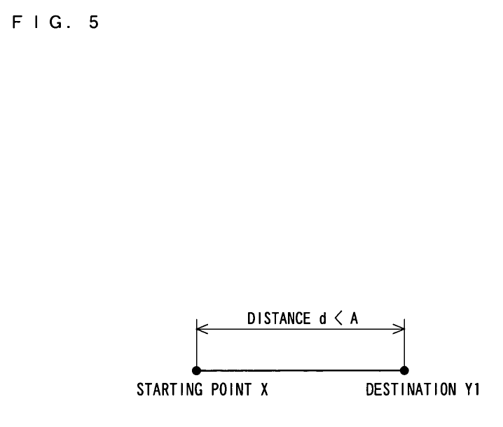

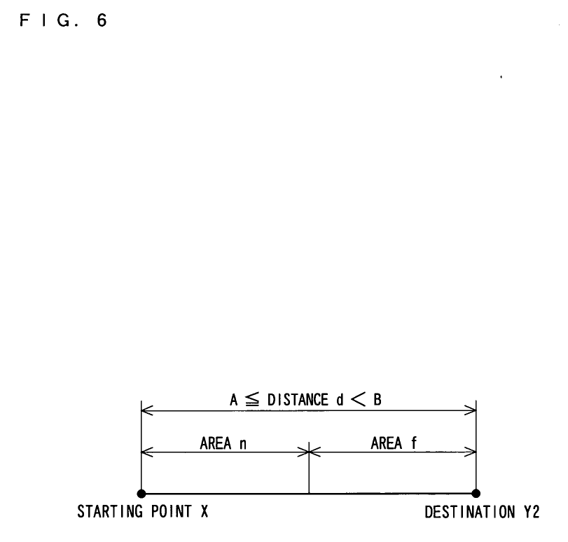

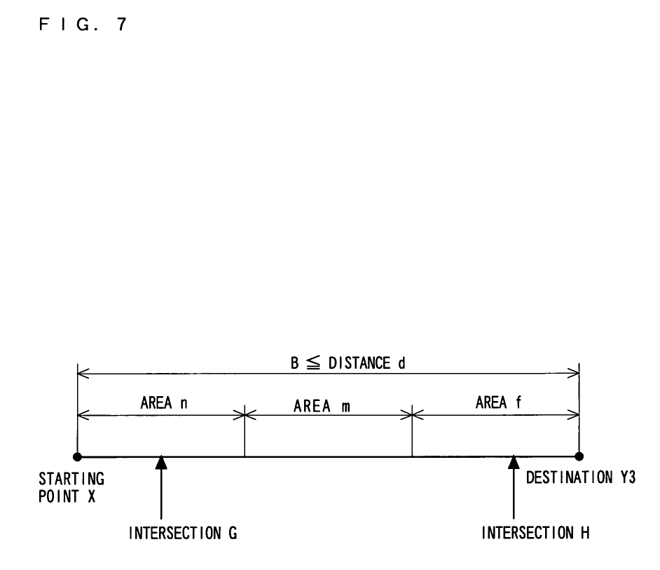

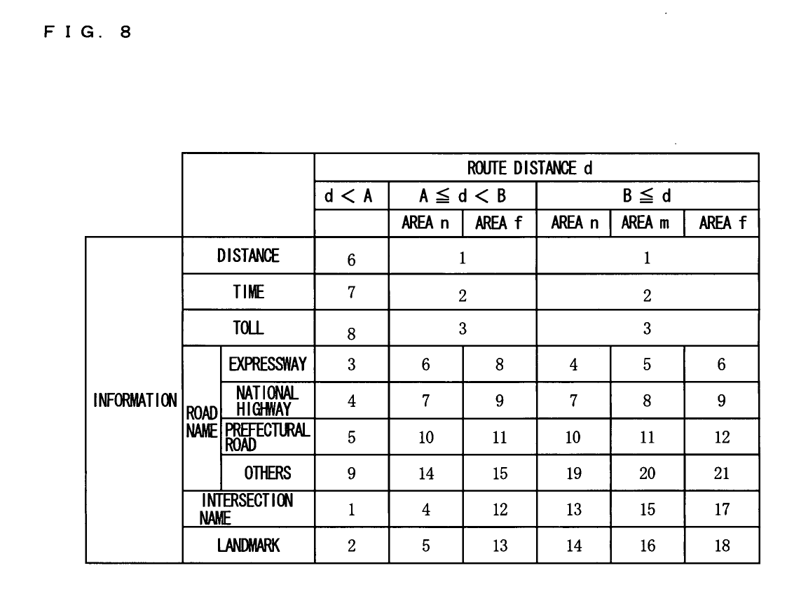

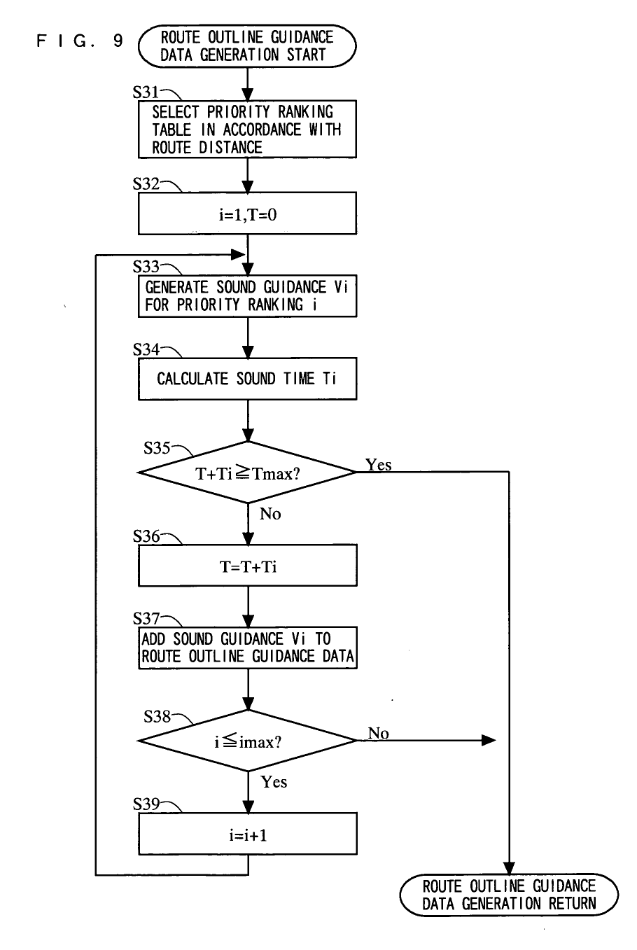

### BRIEF DESCRIPTION OF THE DRAWINGS

[FIG. 1] FIG. 1 is a schematic perspective view of the external configuration of a navigation apparatus according to an embodiment of the present invention.

[FIG. 2] FIG. 2 is a block diagram illustrating the internal configuration of the navigation apparatus of FIG. 1.

[FIG. 3] FIG. 3 is a flowchart illustrating a navigation operation in the navigation apparatus of FIG. 1.

[FIG. 4] FIG. 4 is a subroutine illustrating a detailed operation of a route outline guidance process in step S5 of FIG. 3.

[FIG. 5] FIG. 5 is an illustration of a first example of a starting point and a destination derived from route search.

[FIG. 6] FIG. 6 is an illustration of a second example of a starting point and a destination derived from route search.

[FIG. 7] FIG. 7 is an illustration of a third example of a starting point and a destination derived from route search.

[FIG. 8] FIG. 8 is an exemplary priority ranking table for determining an item for sound guidance in accordance with a route distance.

[FIG. 9] FIG. 9 is a subroutine illustrating a detailed operation for generating route outline guidance data at step S12 of FIG. 4.

### DESCRIPTION OF THE REFERENCE CHARACTERS

1 . . . main body
2 . . . power LED
3 . . . positioning accuracy LED
4 . . . SD card slot
5 . . . remote-control reception section
6 . . . loudspeaker
11 . . . direction sensor
12 . . . speed sensor
13 . . . sensor signal processing section
14 . . . GPS reception section
15 . . . system control section
16 . . . operation section
17 . . . map information acquisition section
18 . . . SD card
19 . . . sound processing section
20 . . . lighting processing section
21 . . . present position detection section
22 . . . route search section
23 . . . sound processing control section
24 . . . positioning accuracy detection section
25 . . . route outline generation section

### BEST MODE FOR CARRYING OUT THE INVENTION

Hereinafter, with reference to the drawings, a navigation apparatus according to an embodiment of the present invention is described. FIG. 1 is a schematic perspective view of the external configuration of the navigation apparatus. The navigation apparatus is mainly to be installed and used in a vehicle or the like.

In FIG. 1, the navigation apparatus according to the present invention has a main body 1. The main body 1 has incorporated therein a GPS (Global Positioning System) receiver for detecting a present position of the navigation apparatus, a direction sensor, a computer including a storage section such as a ROM or the like. As will be expressed in the following description, the navigation apparatus is of a so-called “GYRO-containing” type, which is capable of acquiring information of changes in speed and direction of the vehicle in which the apparatus is installed, and which is also capable of accurate route guidance even in places where GPS radio waves cannot be received, such as under an elevated structure, in a tunnel, or the like. A surface of a housing of the main body 1 has provided thereon a power LED 2, a positioning accuracy LED 3, a SD card (Secure Digital memory card) slot 4, a remote-control reception section 5, and a loudspeaker 6. The navigation apparatus according to the present embodiment is not equipped with a display section such as a display, and performs route guidance employing sound, as will be expressed in the following description.

The power LED 2 displays an on/off state of power of the navigation apparatus. The positioning accuracy LED 3 is a positioning accuracy notification means to make a notification of a current positioning accuracy by an operation of emitting light. The SD card slot 4 is a slot into which is inserted a SD card used as an external auxiliary storage medium for storing map information. Note that the external auxiliary storage medium used for the navigation apparatus according to the present invention is not limited to SD cards but may be a storage medium of a different form, such as a CD, a DVD, or the like. In such a case, the SD card slot 4 would be replaced with a slot adapted to that different form which is used for the external auxiliary storage medium. The remote-control reception section 5 receives a remote-control signal for a user to perform an operation on or setting of the navigation apparatus. The loudspeaker 6 is a sound output section for performing route guidance for the user.

FIG. 2 is a block diagram illustrating the internal configuration of the navigation apparatus according to the present embodiment. In FIG. 2, the navigation apparatus has a self-contained navigation system for a vehicle, the system being composed of a direction sensor 11, a speed sensor 12, and a sensor signal processing section 13. The direction sensor 11 is composed of, e.g., an angular velocity sensor for detecting an angular velocity of the vehicle in which the navigation apparatus is installed. The speed sensor 12 detects the speed or moving distance of the vehicle in which the apparatus is installed. The sensor signal processing section 13 receives signals from the direction sensor 11 and the speed sensor 12 and processes those signals.

In addition to the above-described components, the navigation apparatus includes a GPS reception section 14, a system control section 15, an operation section 16, a map information acquisition section 17, a sound processing section 19, and a lighting processing section 20. The GPS reception section 14 receives radio waves from a plurality of GPS satellites; carries out computation; generates data of a latitude, longitude, height, and moving direction of the navigation apparatus or a reception state such as the number of satellites from which reception is made or the like; and outputs to the system control section 15. The system control section 15 performs various processes such as computation, control, etc., necessary for the operation of the navigation apparatus. The operation section 16 is composed of a keyboard, a remote control, or the like for the user to input an instruction to the system control section 15, and in the case where it is composed of a remote control, a remote-control signal is inputted to the navigation apparatus via the remote-control reception section 5 (FIG. 1). The map information is stored in the SD card 18 inserted into the SD card slot 4, and the map information acquisition section 17 acquires the map information from the SD card 18 as necessary and sends it to the system control section 15. Here, as the external auxiliary storage means for storing the map information, various storage media, such as a CD or a DVD, may also be used besides the SD card 18. The above-described map information includes various information used for common navigation operation, such as distance information, driving time information, turnpike toll information, a road name, an intersection name, a landmark, etc. The sound processing section 19 performs sound processing for performing route guidance by use of sound in accordance with control by the system control section 15, and outputs a sound message signal to the loudspeaker 6. Based on a positioning accuracy detection signal from the system control section 15, the lighting processing section 20 causes the positioning accuracy LED 3 to emit light, thereby notifying the user of the state of the current positioning accuracy.

The system control section 15 includes a present position detection section 21, a route search section 22, a sound processing control section 23, a positioning accuracy detection section 24, and a route outline generation section 25. The system control section 15 is, for example, composed of a computer equipped with a storage section (not shown) such as a ROM or the like, and the computer executes a navigation program stored in the storage section to allow each component within the system control section 15 to function. The present position detection section 21 is a positioning means to detect the present position of the vehicle in which the navigation apparatus is installed, based on a signal processed by the sensor signal processing section 13 and a detection signal from the GPS reception section 14. The route search section 22 searches for a route from a starting point to a destination in response to an input of an instruction from the operation section 16. The route outline generation section 25 generates an outline of the route found by the route search section 22. The sound processing control section 23 controls sound processing for performing route guidance during operation of the navigation apparatus or making an explanation of the outline of the route generated by the route outline generation section 25, by use of sound. The positioning accuracy detection section 24 detects whether the positioning accuracy detected by the present position detection section 21 is satisfactory or not.

With reference to FIG. 3 to FIG. 9, an operation of the navigation apparatus according to the present embodiment is described. FIG. 3 is a flowchart illustrating a navigation operation in the navigation apparatus. FIG. 4 is a subroutine illustrating a detailed operation of a route outline guidance process in step S5 of FIG. 3. FIG. 5 to FIG. 7 are illustrations of specific examples of a starting point and a destination derived from route search. FIG. 8 is an exemplary priority ranking table for determining an item for which a sound guidance is performed based on the route distance. FIG. 9 is a subroutine illustrating a detailed operation for generating route outline guidance data in step S12 of FIG. 4.

In FIG. 3, if power of the navigation apparatus is turned on, the computer executes the navigation program stored in the storage section, thereby activating the system control section 15. Then, through a control operation by the system control section 15, the map information acquisition section 17 reads the map information from the SD card 18 and holds the data. Meanwhile, the direction sensor 11 and the speed sensor 12 acquire respective signals necessary for self-contained navigation computation, and those signals are processed by the sensor signal processing section 13. The GPS reception section 14 acquires reception data from a GPS satellite. The present position detection section 21 performs predetermined computation based on the data processed by the sensor signal processing section 13, thereby calculating a position and moving direction of the vehicle; and compares this calculation information with the information from the GPS reception section 14 and compensates a difference therebetween, thereby detecting the present position of the vehicle (step S1). The present position thus detected is set as a starting point.

Next, the user utilizes the operation section 16 to enter a destination for which route guidance is to be performed, whereby the destination used by the route search section 22 is set (step S2). Once the destination is set, the route search section 22 searches a route from the starting point to the destination (step S3). For calculation in this route search, a common Dijkstra's algorithm or the like can be used. Next, in a similar manner as in the above-described step S1, the present position detection section 21 acquires the present position of the vehicle again (step S4). Then, the route outline generation section 25 operates based on route data obtained by the above-described step S3, whereby the route outline guidance process is performed (step S5). The details of this route outline guidance process are described further below.

Next, data of the present position detected by the present position detection section 21 in the above-described step S4 is supplied to the sound processing control section 23, and the sound processing control section 23 performs a route guidance process for the present position of the vehicle, based on the route data obtained by the above-described step S3 (step S6). For example, a sound message, such as “You will pass A Street in a moment”, “You will reach B Bridge in a moment”, “Turn the next intersection to the right”, etc., is outputted from the loudspeaker 6 via the sound processing section 19. Further, if the destination or the like is changed, a route search is performed again by the route search section 22, and based on the updated route, the route guidance process is performed. As described above, the navigation apparatus according to the present embodiment performs route guidance by use of sound alone, without using displayed information involving use of a display or the like. Therefore, the sound message for the above-described route guidance contains contents so detailed as to equal an amount of information when the contents of the route guidance were displayed on the display.

Next, the system control section 15 checks whether the vehicle has reached the set destination (step S7). If the vehicle has not reached the destination, the system control section 15 returns to the above-described step S4, and repeats the processes. On the other hand, if the vehicle has reached the destination, the system control section 15 completes the procedure according to this flowchart.

Note that the process performed in step S7 is not limited to checking whether the vehicle has reached the destination. For example, the system control section 15 may check “whether discontinuation of the route guidance has been instructed”, or both of the checking processes may be performed one after the other.

Next, with reference to FIG. 4, a detailed operation of the route outline guidance process in the above-described step S5 is described.

First, the system control section 15 determines whether a guidance of a route outline is necessary (step S11). Herein, the route outline is for a simple explanation of the route for which the route guidance will be performed for the user, and is presented so that the user can recognize in advance the route for which the route guidance will be performed presently. Sound guidance of the route outline allows the user to know in advance a route to the destination, whereby he or she can determine whether he or she should drive along the route indicated by the route outline, for example. For example, in the case where an outline guidance for the set route has not been performed for the user, e.g., in the case where no route outline guidance has been performed for the set route since the system is powered up, or in the case where the route is changed and no route outline guidance has been performed for that updated route, the system control section 15 determines that a route outline guidance is necessary. On the other hand, in the case where a route outline guidance has already been performed for the user, because repeated performing of the outline guidance for the same route is simply annoying to the user, the system control section 15 determines that the guidance of the route outline is not necessary. In the case where the system control section 15 determines that the route outline guidance is necessary in the above-described step S11, control proceeds to the next step S12. On the other hand, in the case where the system control section 15 determines that the route outline guidance is not necessary, the procedure of the present subroutine is finished.

At step S12, the route outline generation section 25 generates route outline guidance data based on the route data generated by the route search section 22. A process of generating this route outline guidance data is described in detail further below. Then, the route outline guidance data generated in the above-described step S12 is supplied to the sound processing control section 23, and the sound processing control section 23 performs route outline guidance by use of sound based on the route outline guidance data (step S13). Then, the procedure according to this subroutine is completed.

Here, the route outline guidance is described. As described earlier, the navigation apparatus according to the present embodiment does not have a display. Therefore, in contrast to a conventional navigation apparatus which has a display, it is impossible to perform prior route guidance by presenting to the user the route derived from the search so as to be superposed on a map displayed on the display, or displaying in detail a name, a distance, or the like for each point to be passed along the route from the starting point to the destination. Simply presenting such guidance by use of sound only results in an enormous amount of information being presented by use of sound for a long time, which would be simply annoying to the user. Therefore, in the route outline guidance in the navigation apparatus according to the present embodiment, the guidance of the route derived from the search is not provided at length with respect to a name of a place on the way, a road name, a distance, right/left turn at an intersection, etc.; instead, a guidance of a simple route (route outline) obtained by appropriate selection of information by the route outline generation section 25 is presented by use of sound.

For example, information presented in the route outline by use of sound is information included in the map information or the like acquired by the map information acquisition section 17, e.g., a distance of the route, an estimated driving time for the route, a toll cost for the route, a road name for the route, an intersection where a turn is to be made in the route, a landmark close to a point where a turn is to be made in the route, etc. Specifically, sound for presenting the distance of the route as the route outline would say, “The driving distance is 30 km”. Sound for presenting the estimated driving time for the route as the route outline would say, “The estimated driving time is one hour and twenty minutes”. Sound for presenting the toll cost for the route as the route outline would say, “The toll cost is 1250 Yen”. Sound for presenting the road name for the route as the route outline would say, “This is a route using Route 1 and the Tomei Expressway”. Sound for presenting the intersection where a turn is to be made in the route as the route outline would say, “This is a route which requires a turn to the left at Ginza 1-chome”. Sound for presenting the landmark close to a point where a turn is to be made in the route as the route outline would say, “This is a route which requires a turn to the right in front of the Ikebukuro Sunshine 60”.

As mentioned earlier, in the route outline guidance, if all pieces of information with respect to the set route are simply enumerated, the guidance will take a long time without presenting an overall feature of the route, resulting in the user becoming confused. Therefore, in the route outline guidance, a simple guidance of a grasped feature of the set route should be provided so that the user can easily understand the route. In the present embodiment, pieces of information suitable for the route outline guidance are appropriately selected to provide a simple, grasped feature of the set route. As a method of selecting pieces of information used for this route outline guidance, previously assigning a level of importance (priority) to pieces of information is conceivable. For example, among road names, the assignment of the level of importance is made such that higher levels of importance are assigned in this order: an expressway>a national highway>a prefectural road. Among places on the way, a higher level of importance is set for a landmark such as a station, a place of interest, etc., and for a famous intersection for which road information is frequently provided. With respect to the route derived from the search, some pieces of information having high levels of importance may be selected for sound guidance. In this case, pieces of information having high levels of importance may concentrate in one area. The concentration of the selected pieces of information in one area can be prevented by selecting a predetermined number of pieces of information having the highest levels of importance in each one of the following areas obtained by dividing the entire area into three parts: an area around the starting point, an area around the destination, and an intermediate area located between the two areas.

With reference to FIG. 5 to FIG. 9, a procedure for generating route outline guidance data for performing the above-described route outline guidance is described. In the route outline guidance according to the present embodiment, the route outline guidance data is generated such that the total time for sound guidance will be within a time period Tmax. Priority rankings are assigned to pieces of information to be presented, pieces of sound information are selected based on the priority rankings and added, and the addition of the pieces of sound information is controlled so that the time period Tmax will not be surpassed.

The priority rankings assigned to pieces of information to be presented vary based on a distance of the entire route that is set (a distance from the starting point to the destination; hereinafter referred to as a “route distance d”), a distance to the starting point, or a distance to the destination. For example, the set route is classified as one of the following three types: a route whose route distance d from a starting point X to a destination Y1 is shorter than a distance A (see FIG. 5), a route whose route distance d from the starting point X to a destination Y2 is equal to or longer than the distance A and shorter than a distance B (see FIG. 6), and a route whose route distance d from the starting point X to a destination Y3 is equal to or longer than the distance B (see FIG. 7).

For example, in the case of the route whose route distance d from the starting point X to the destination Y1 is shorter than the distance A as illustrated in FIG. 5, the destination Y1 is located relatively close to the starting point X. In this case, generally speaking, information necessary for the user would be the name of an intersection where a turn is to be made in the route, a landmark at a point where a turn is to be made, etc., rather than the distance of or the estimated driving time for the set route. Therefore, the assignment of priority rankings to pieces of information to be presented is performed such that higher priority rankings are set for pieces of information as to an intersection where a turn is to be made in the route or a landmark close to a point where a turn is to be made in the route.

For example, in the case of the route whose route distance d from the starting point X to the destination Y3 is equal to or longer than the distance B as illustrated in FIG. 7, the destination Y3 is located relatively far from the starting point X. In this case, generally speaking, information necessary for the user would be information which allows grasping of the overall route rather than detailed information as to an intersection or information as to a name of a road other than a main road. Therefore, the assignment of priority rankings to the pieces of information to be presented is performed such that higher priority rankings are set for information as to the distance of the route, the estimated driving time for the route, and the road name for the route. However, even in the case of a route having a relatively far destination, information as to an intersection, located close to the starting point, where a turn is to be made, etc., would be important information. Accordingly, as illustrated in FIG. 7, the entire route is divided into three parts having the same distance, and an area close to the starting point X is set to an area n, an area close to the destination Y3 is set to an area f, and an area intermediate between the area n and the area f is set to an area m. A priority ranking assigned to information as to an intersection belonging to the area n, which is close to the starting point X, is set to be higher as compared to another area. As a result of setting priority rankings in this manner, information as to an intersection G, which belongs to the area n, is more likely to be added to the route outline guidance data than that of an intersection H, which belongs to the area f, as illustrated in FIG. 7. In the case of the route whose route distance d from the starting point X to the destination Y2 is equal to or longer than the distance A and shorter than the distance B as illustrated in FIG. 6, the entire route is divided into two parts having the same distance, and priority rankings are set in a similar manner.

FIG. 8 is an exemplary priority ranking table created according to the above-described rule for the assignment of the priority rankings. As illustrated in FIG. 8, priority rankings are assigned to pieces of information in accordance with the route distance d and the areas within the set route. Note that, in the priority ranking table of FIG. 8, smaller numbers indicate higher priority rankings.

With reference to FIG. 9, a detailed operation for generating the route outline guidance data at step S12 of FIG. 4 is described. The route outline generation section 25 calculates the route distance d for the route which is set after the search by the route search section 22 (see step S3), and selects a priority ranking table in accordance with the route distance d (step S31). Then, the route outline generation section 25 sets a guidance time T to 0 (T=0), and sets a priority ranking i to 1 (i=1), thereby initializing temporary variables used in the subroutine (step S32).

Next, the route outline generation section 25 consults the priority ranking table (see FIG. 8) selected in the above-described step S31, extracts a piece of information associated with the priority ranking i, and generates a sound guidance Vi (step S33). Then, the route outline generation section 25 calculates a sound time Ti required for presenting the sound guidance Vi generated in the above-described step S33 by use of sound (step S34).

Next, the route outline generation section 25 determines whether or not a time resulting from adding the sound time Ti to the guidance time T is equal to or longer than a maximum sound guidance time Tmax, which is previously set (step S35). Then, in the case where it is shorter than the maximum sound guidance time Tmax, the route outline generation section 25 proceeds to a process of the next step S36, and in the case where it is equal to or longer than the maximum sound guidance time Tmax, the procedure according to this subroutine is completed.

At step S36, the route outline generation section 25 adds the sound time Ti to the guidance time T, thereby updating the guidance time T (step S36). Then, the route outline generation section 25 adds the sound guidance Vi generated in the above-described step S33 to the route outline guidance data (step S37).

Next, the route outline generation section 25 determines whether or not the priority ranking i is equal to or less than a minimum priority ranking imax, which is previously set (step S38). In the case where it is equal to or less than the minimum priority ranking imax, the route outline generation section 25 adds one to the priority ranking i, thereby updating the priority ranking i (step S39), returns to the above-described step S33, and repeats the above processes. On the other hand, in the case where the priority ranking i is greater than the minimum priority ranking imax, the route outline generation section 25 completes the procedure according to this subroutine.

As described above, the navigation apparatus according to the present embodiment is capable of informing the user of an outline of a route by use of sound, before starting an actual route guidance following the setting of the route. This allows the user to recognize the route safely in advance even in a situation where he or she cannot turn his or her eyes because he or she is driving, for example. At this time, a simple route outline which allows the user to easily understand the route is presented via the loudspeaker, e.g., “This is a route which first utilizes Route C and then the D Expressway, and the toll for the expressway is E”. As a result, the user is able to efficiently recognize the route which is presented.

The frequency with which the user has so far driven on a road or driven by a place, and so on, may be stored with respect to a road, a place, etc., and the assignment of priority rankings may be performed such that lower priority rankings are set for pieces of information associated with an area for which that frequency is large. Thus, an amount of information selected in the route outline guidance may be decreased in connection with an area with which the user is familiar, whereas an amount of information selected in the route outline guidance may be increased in connection with an area where the user has not driven before. Therefore, it is possible to perform the route outline guidance considering areas where the user has driven so far.

Also, the above-described priority rankings may be permitted to be changed by the user. For example, in the case where an expressway is included in a route which is set, it is conceivable that the user, who is concerned with using a toll road, sets a high priority ranking for a piece of information as to a toll of the expressway. Also, it may be so arranged that only the pieces of information which the user wishes to be adopted for the route outline guidance be selected.

### INDUSTRIAL APPLICABILITY

A navigation apparatus and method, and a navigation program according to the present invention allow a route outline guidance to be performed by use of sound, before a route guidance is performed, and are usable as a navigation apparatus and method, and a navigation program which perform a navigation operation using an apparatus which is not equipped with a display device.

1. A navigation apparatus for performing a route guidance by use of sound based on a route which is set, the apparatus comprising:
a map information acquisition section for acquiring pieces of map information;
a present position detection section for detecting a present position;
a route search section for performing a search for a route from a starting point to a destination, while employing the pieces of map information acquired by the map information acquisition section, to set the route;
a route outline generation section for generating outline data of the route by appropriately selecting a piece of map information as to the route set by the route search section; and
a sound processing control section for performing a guidance of the route by use of sound based on the present position in the route set by the route search section, wherein,
based on the outline data of the route generated by the route outline generation section, the sound processing control section presents information of an outline of the route by use of sound, before performing the guidance of the route based on the present position, and
the route outline generation section assigns priority rankings to respective information types, and appropriately selects a piece of information based on the priority rankings to generate the outline data of the route.

2-3. (canceled)

4. The navigation apparatus according to claim 1, wherein in accordance with a total distance of the route set by the route search section, the route outline generation section varies the priority rankings assigned to the respective information types.

5. The navigation apparatus according to claim 4, wherein when the total distance of the route set by the route search section is relatively short, the route outline generation section performs assignment of the priority rankings such that high priority rankings are set for pieces of information as to an intersection where a turn is to be made in the route and a landmark near the intersection.

6. The navigation apparatus according to claim 4, wherein when the total distance of the route set by the route search section is relatively long, the route outline generation section performs the assignment of the priority rankings such that high priority rankings are set for pieces of information as to a distance of, an estimated driving time for, and a road name for the route.

7. The navigation apparatus according to claim 1, wherein the route outline generation section divides the route set by the route search section into a predetermined number of parts, and varies the priority rankings assigned to the respective information types belonging to each area obtained by division.

8. The navigation apparatus according to claim 7, wherein the route outline generation section performs the assignment of the priority rankings such that higher priority rankings are set for an information type belonging to an area including the starting point than for an identical information type belonging to another area.

9. A navigation program to be executed by a computer in a navigation apparatus for performing a route guidance by use of sound based on a route which is set, the program causing the computer to perform:
a map information acquisition step for acquiring pieces of map information;
a present position detection step for detecting a present position;
a route search step for performing a search for a route from a starting point to a destination, while employing the pieces of map information acquired by the map information acquisition step, to set the route;
a route outline generation step for generating outline data of the route by appropriately selecting a piece of map information as to the route set by the route search step; and
a sound processing control step for performing a guidance of the route by use of sound based on the present position in the route set by the route search step, wherein,
based on the outline data of the route generated by the route outline generation step, the sound processing control step presents information of an outline of the route by use of sound, before performing the guidance of the route based on the present position, and
the route outline generation step assigns priority rankings to respective information types and appropriately selects a piece of information based on the priority rankings to generate the outline data of the route.

10. A navigation method for performing a route guidance by use of sound based on a route which is set, the method comprising:
a map information acquisition step for acquiring pieces of map information;
a present position detection step for detecting a present position;
a route search step for performing a search for a route from a starting point to a destination, while employing the pieces of map information acquired by the map information acquisition step, to set the route;
a route outline generation step for generating outline data of the route by appropriately selecting a piece of map information as to the route set by the route search step; and
a sound processing control step for performing a guidance of the route by use of sound based on the present position in the route set by the route search step, wherein
based on the outline data of the route generated by the route outline generation step, the sound processing control step presents information of an outline of the route by use of sound, before performing the guidance of the route based on the present position, and
the route outline generation step assigns priority rankings to respective information types and appropriately selects a piece of information based on the priority rankings to generate the outline data of the route.
